(19) United States
(12) Patent Application Publication
(10) Pub. No.: US 2009/0156232 A1
(43) Pub. Date: Jun. 18, 2009

(54) Mobile telephone with distance measurement and data collection capability

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI , HEWITT & AREZINA LLC, ONE NORTH LASALLE STREET, 44TH FLOOR, CHICAGO, IL, 60602, US

(21) Appl. No.: 12/002,574

(22) Filed: Dec. 18, 2007

(51) Int. Cl. H04Q 7/20

(52) U.S. Cl. 455/456.3

(57) ABSTRACT

An exemplary wireless mobile telephone includes a transmitter and receiver module for transmitting and receiving radio communications, and a display screen. A mechanism acquires linear distance measurements to objects within line of sight of the wireless mobile telephone. A graphical representation of a structure having elements to be measured is stored in memory. A microprocessing unit operating under the control of software stores in the memory a plurality of the linear distance measurements, where each stored linear distance measurement is associated with a corresponding element of the graphical representation as shown on the display screen. This enables areas defined by a pair of such elements to be calculated.

### BACKGROUND

This invention relates generally to mobile telephones and more specifically to a mobile telephone with integrated distance measurement functionality.

Wireless mobile telephones provide communications such as internet access and email capabilities in addition to 2-way voice communications. An additional function on some mobile telephones is a camera.

Standalone measuring devices such as a laser based linear measurement device are available. While such devices can provide accurate measurement readings, it is often inconvenient to record, store, and/or keep track of such readings, especially where a large number of measurements are to be made. For example, determining the interior square footage of a house having several rooms requires a series of linear measurements that must be manually recorded in pairs in order to later calculate the square footage of each room. There exists a need for an integrated apparatus and method that can provide 2-way communications as well as conveniently record, store and keep track of linear distance measurements

### SUMMARY

It is an object of the present invention to satisfy this need.

An exemplary embodiment of a wireless mobile telephone includes a transmitter and receiver module for transmitting and receiving radio frequency communications, and a display screen. A mechanism acquires linear distance measurements to objects within line of sight of the wireless mobile telephone. A graphical representation of a structure having elements to be measured is stored in memory. A microprocessing unit operating under the control of software stores in the memory a plurality of the linear distance measurements, where each stored linear distance measurement is associated with a corresponding element of the graphical representation as shown on the display screen. This enables areas defined by a pair of such elements to be calculated.

An exemplary method makes distance measurements utilizing a wireless mobile telephone. A graphical representation of a structure having elements to be measured is stored in memory of the wireless mobile telephone and displayed on a screen of the wireless mobile telephone. Linear distance measurements to objects within line of sight of the wireless mobile telephone are acquired and stored in the memory together with an association with one of a selected element of the graphical representation as shown on the display screen.

### DESCRIPTION OF THE DRAWINGS

Features of exemplary implementations of the invention will become apparent from the description, the claims, and the accompanying drawings in which:

FIG. 1 is a block diagram of an exemplary system suited for incorporation of an embodiment of the present invention.

FIG. 2 is a block diagram of an exemplary wireless mobile handset in accordance with the embodiment of the present invention.

FIG. 3 is a flow diagram illustrating steps in accordance with an embodiment of the method in accordance with the present invention.

FIG. 4 is an enlarged view of an exemplary display screen of a wireless mobile handset.

FIG. 5 shows exemplary records and corresponding calculations in accordance with an embodiment of the present invention.

### DETAILED DESCRIPTION

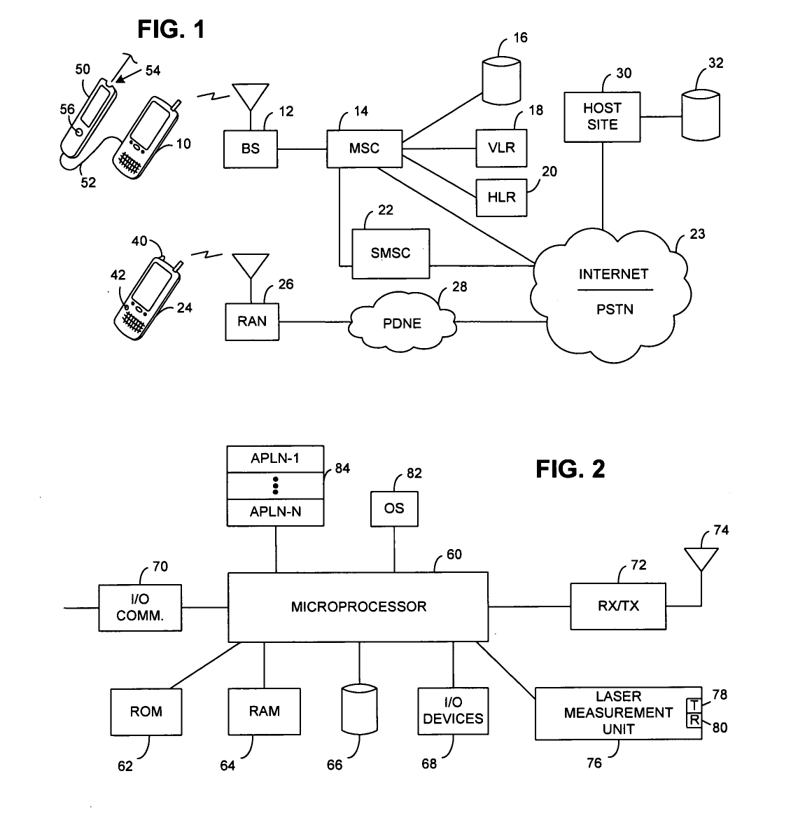

Referring to FIG. 1, an exemplary telecommunication network includes a first system that supports wireless cellular subscribers with voice communications and SMS messaging, and a second system that is independent of the first system and provides wireless broadband data services. A first subscriber utilizes a wireless device 10 such as a cellular telephone with SMS data capabilities. The first system includes base station (BS) 12 that supports wireless communications between the device 10 and a mobile switching center (MSC) 14. The MSC is supported by a database 16, visiting location register (VLR) 18, home location register (HLR) 20, and a short messaging service center (SMSC) 22 that supports SMS and email communications with other devices coupled to the internet portion of network 23. Voice communications between the MSC 14 and other MSCs or equipment are supported by the Public Switched Telephone Network (PSTN) portion of network 23.

In the second system, a second subscriber utilizes a wireless device 24 that supports broadband wireless capabilities and preferably includes a browser for interfacing with internet communications, e.g. TCP/IP transmissions. A radio access network (RAN) 26 supports communications between the device 24 and packet data network equipment (PDNE) 28. The PDNE supports communications between the RAN 26 and the PSTN and internet of network 23. The specific equipment that makes up the PDNE varies depending on the communications technology/format utilized, e.g.:

for HRPD (High Rate Packet Data—a high-speed CDMA-based wireless data technology): a PCF (Packet Control Function) device, a PDSN (Packet Data Service Node) device, Foreign and Home Agent devices, and an AAA server.

for GPRS (General Packet Radio Service): a SGSN (Serving GPRS Support Node) device, a GGSN (Gateway GPRS Support Node) device, VLR and HLR devices.

for CDMA (Code Division Multiple Access) IS-95: IWF (Interworking Function) device and an AAA server.

The first and second systems are connected by the internet of network 23 to a host site 30 having an associated database 32. The host site 30 provides an interface for wireless subscribers such as using devices 10 and 24 to a variety of templates stored in database 32. The templates provide a framework that assists the subscribers in collecting and storing linear measurements made by the subscriber as will be explained in more detail below.

The exemplary mobile handset devices 10 and 24 each include the capability of making linear measurements such as by a laser measurement device. As used herein, a linear measurement means the measurement of a distance as determined along a straight line from the mobile telephone handset or a local device coupled to the handset to an object without the assistance of external information such as global positioning satellite information or similar information. The laser measurement device can be contained within the housing of the handset, as in the illustrative device 24. The laser measurement device emits a laser beam from port 40, receives reflections, and has separate measurements controlled by the depression of a button 42. Alternatively, a laser measurement device 50 is housed separate from the handset 10 and is coupled to the handset by a cable 52 (or Bluetooth local wireless connection, Infrared, etc.). The laser measurement device 50 emits a laser beam from port 54, receives beam reflections, and has separate measurements controlled by the depression of a button 56. In both handsets 10 and 24, the measurement readings are coupled to the handset and stored in memory. In a further enhanced functionality, the measurement readings are associated with a measurement template that has been previously downloaded into the handset from database 32. The collected measurements stored in memory of the handset can then be transmitted as an SMS message, email or data to another device or site. This will be explained in more detail below.

FIG. 2 is a block diagram of an illustrative embodiment of a mobile handset 24. The functionality of the handset is provided by microprocessor 60 which is supported by read-only memory (ROM) 62, random access memory (RAM) 64, and nonvolatile memory 66 such as flash memory, EEPROM, etc. Input/output (I/O) devices 68 may include input devices such as a keypad, measurement activation button 42, other buttons such as for cursor movement, screen selection, etc., microphone, and an input port jack. The output devices may include a display screen and a speaker. An input/output communication module 70 supports two-way communications between the microprocessor 60 and external devices such as connected by a cable to the input port jack or by Bluetooth technology. A transmit and receive module 72 coupled to antenna 74 provides radio frequency communication support with a base station or radio access node. A laser measurement unit 76 includes a transmission port 78 through which the laser beam is transmitted and a receive port 80 by which reflections of the laser beam are received and processed to determine the distance to the object providing the reflections. The microprocessor 60 operates under the control of an operating system 82 which provides basic operational functionality and serves to support application programs 84 that provide higher-level functionality including distance measurement storage associated with templates in accordance with an embodiment of the present invention.

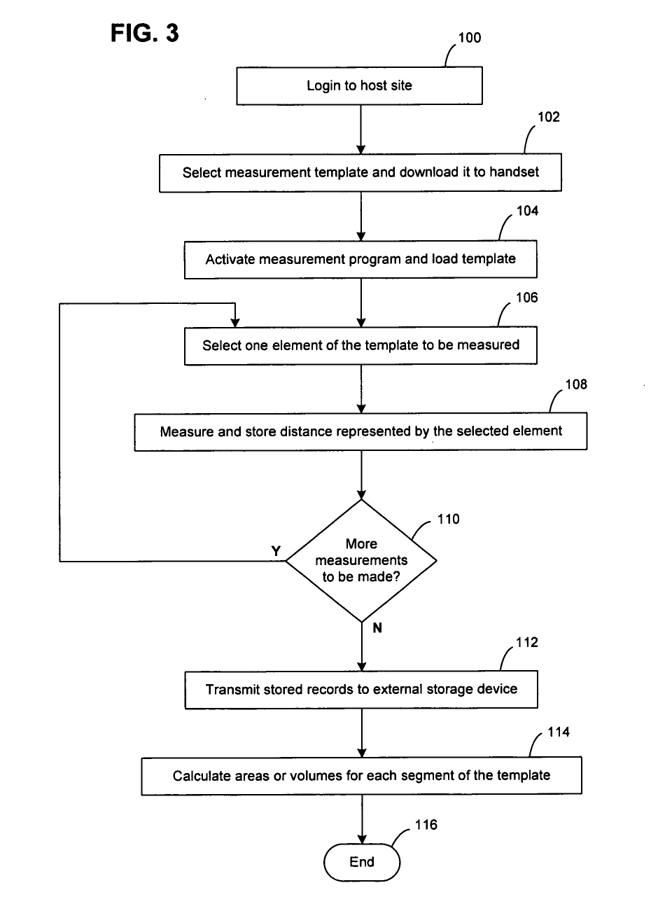

FIG. 3 is a flow diagram of steps of an exemplary embodiment of a method in accordance with the present invention. To assist in understanding the described steps, it will be assumed that mobile handset 24 is in communication with host site 30. In step 108 a subscriber uses the wireless mobile handset 24 to login to a host site 30. It will be understood that the login process will include subscriber identification and preferably some form of authentication such as the use of a password. In step 102 the subscriber selects a measurement template from among a plurality of stored measurement templates in database 32 and downloads the selected measurement template to handset 24. In this example the subscriber is a realtor who selects a template corresponding to a specific house plan for a house for which the realtor desires to determine square-foot measurements for each room. It will be understood that various types of buildings and structures can be represented by an appropriate template that has a corresponding geometric outline. For example, various types of fences, parcels of land, vehicles, and other objects can be represented by an appropriate template having a corresponding geometric outline.

In step 104 the subscriber activates the measurement program in mobile handset 24 and loads the selected template. In a preferred embodiment a visual representation of the geometry associated with the selected template is displayed on the screen of the mobile handset. In step 106 the subscriber selects one element of the template to be measured such as by using a graphical user interface to select one element as displayed on the screen of the handset, e.g. the subscriber selects a wall associated with a room to be measured. In step 104 the subscriber, after positioning the mobile handset at a location and in a direction so as to measure the length of the selected wall, presses button 42 causing the laser measurement unit to measure the length of the selected wall. This measurement representing the length of the wall, such as measured in feet, is stored in the mobile handset in association with the identified wall. For example, a record may be used to store the measurement and a label identifying the wall that was measured. In step 110 a determination is made of whether more measurements are to be made. This determination may be manually made by the subscriber. Alternatively, the measurement program may automatically make this determination based on whether measurements have been made of all elements that comprise the selected template. A YES determination by step 110 results in further measurements being made for selected elements of the template as indicated by a return to step 106. A NO determination by step 110 results in the stored measurement records being transmitted to an external storage device, e.g. database 32 in accordance with step 112. In step 114 the areas and/or volumes are calculated for each segment of the template based on the measurements associated with each segment. Alternatively, the mobile handset itself may be used to implement step 114 assuming the handset has sufficient memory storage and computational capabilities. This method terminates at END step 116.

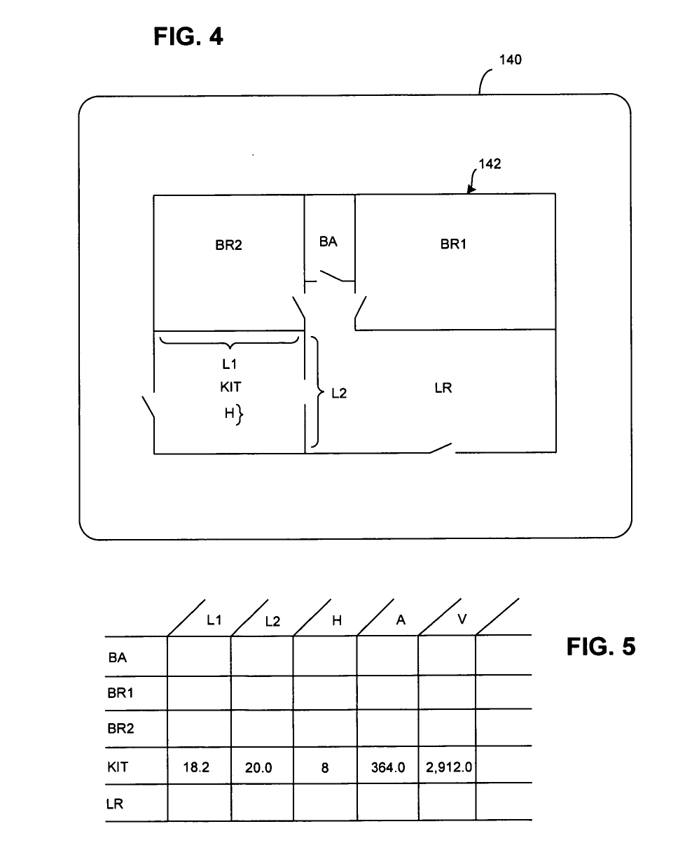

FIG. 4 shows an enlarged representation of a display screen 140 of mobile handset 24. In accordance with the example described with regard to FIG. 3, a visual representation 142 of a selected template of a top view of a house is shown. This template was selected and downloaded by the subscriber (realtor) because of its close correspondence to the house for which the realtor is to determine square footage measurements for its rooms. In this example, the house contains a first bedroom (BR 1), a second bedroom (BR 2), a bathroom (BA), a kitchen (KIT), and a living room (LR). Each of the walls that define the respective rooms can be selected by the subscriber such as by causing a pointing device associated with the display screen to hover over the wall and entering a selection button. To determine and store measurements associated with the kitchen, the user could select wall L1 of the kitchen and make a corresponding measurement; then select wall L2 of the kitchen and make a corresponding measurement. These two measurements are stored in association with the respective selected walls of the kitchen so that a determination of the square footage of the kitchen can be calculated. If a volume of room is to be determined, an additional measurement of the height (H) can also be made and stored in association with that room. In a like manner, one of each of the opposing walls in each room can be identified, measured, and stored.

FIG. 5 shows exemplary records associated with the measurements described herein and calculations based on these measurements. The records will reflect corresponding measurements for each of the rooms as shown in FIG. 4 that were measured. Each room represents a predetermined pair of opposing walls (elements) to be used for an area determination. With respect to the kitchen, the record reflects that the wall L1 was measured to be 18.2 feet and the wall L2 was measured to be 20.0 feet. In addition, the height (H) of the kitchen was measured to be 8 feet. This results in a calculated area of the kitchen of 364.0 square feet and a calculated volume of the kitchen of 2912.0 cubic feet. Although only the measurements and corresponding calculations are shown for the kitchen, it will be understood that corresponding measurements and resulting calculations would normally be entered by the user for each of the rooms.

The exemplary handset in one example employs one or more computer-readable signal-bearing tangible media. The computer-readable signal-bearing media store software, firmware and/or assembly language for performing one or more portions of one or more embodiments of the invention. The computer-readable signal-bearing medium may comprise one or more of a magnetic, electrical, optical, biological, and atomic data storage tangible medium. For example, the computer-readable signal-bearing medium comprise floppy disks, magnetic tapes, CD-ROMs, DVD-ROMs, hard disk drives, flash memory, PROM, and electronic memory.

Although exemplary implementations of the invention have been depicted and described in detail herein, it will be apparent to those skilled in the art that various modifications, additions, substitutions, and the like can be made without departing from the spirit of the invention. For example, steps in the method can be omitted, performed in a different order, and/or performed by other devices. Distance measurements can be made by using other energy types, e.g. acoustic, infrared, etc. Elements to be measured can be identified by indicia or labels in a table instead of in a graphical representation. A measurement can be made before a corresponding element has been selected, and then the measurement associated with a selected element. Potential users of such a device include realtors, contractors, landscapers, interior designers and building inspectors.

The scope of the invention is defined in the following claims.

We claim:

1. A wireless mobile telephone comprising:
a transmitter and receiver module for transmitting and receiving radio frequency communications;
a display screen;
a means for acquiring linear distance measurements to objects within line of sight of the wireless mobile telephone;
memory for storing a graphical representation of a structure having elements to be measured;
microprocessing unit operating under the control of software that stores in the memory a plurality of the linear distance measurements made by the acquiring means, where each stored linear distance measurement is associated with a corresponding element of the graphical representation as shown on the display screen.

2. The wireless mobile telephone of claim 1 wherein the transmitter transmits the stored linear distance measurements and the respective corresponding elements of the graphical representation to another device so that areas defined by pairs of the linear distance measurements can be calculated.

3. The wireless mobile telephone of claim 1 wherein the microprocessing unit calculates areas based on pairs of the stored linear distance measurements associated with pairs of corresponding elements of the graphical representation for which areas are to be calculated.

4. The wireless mobile telephone of claim 3 wherein the microprocessing unit automatically selects pairs of the stored linear distance measurements for the calculation of areas based on predetermined pairs of corresponding elements of the graphical representation for which areas are to be calculated.

5. The wireless mobile telephone of claim 4 wherein the graphical representation is of a house and the elements of the graphical representation are walls that define rooms within the house, the automatically selected pairs of the stored linear distance measurements correspond to first and second adjacent walls of rooms for which areas are to be calculated.

6. The wireless mobile telephone of claim 1 wherein the microprocessing unit in cooperation with the transmitter and receiver module permits a user to access a remote device containing a plurality of graphical representations, and supports the downloading of a selected graphical representation from the remote device for storage in the memory.

7. The wireless mobile telephone of claim 1 wherein the means for acquiring comprises a measurement module disposed within a housing of the wireless mobile telephone that uses a laser beam to determine distance.

8. The wireless mobile telephone of claim 7 further comprising a button operable by a user, where the button upon depression causes the means for acquiring to make a linear distance measurement.

9. The wireless mobile telephone of claim 1 wherein the means for acquiring comprises a measurement module coupled to and in the presence of the wireless mobile telephone that uses a laser beam to determine distance.

10. A method for making distance measurements utilizing a wireless mobile telephone comprising the steps of:
storing in memory of the wireless mobile telephone a graphical representation of a structure having elements to be measured;
displaying on a screen of the wireless mobile telephone the graphical representation;
acquiring linear distance measurements to objects within line of sight of the wireless mobile telephone;
storing in the memory each linear distance measurement together with an association with one of a selected element of the graphical representation as shown on the display screen.

11. The method of claim 10 wherein the stored linear distance measurements and the respective corresponding elements of the graphical representation are transmitted to another device so that areas defined by pairs of the linear distance measurements can be calculated.

12. The method of claim 10 further comprising the step of calculating areas by a microprocessing unit based on pairs of the stored linear distance measurements associated with pairs of corresponding elements of the graphical representation for which areas are to be calculated.

13. The method of claim 12 wherein the microprocessing unit automatically selects pairs of the stored linear distance measurements for the calculation of areas based on predetermined pairs of corresponding elements of the graphical representation for which areas are to be calculated.

14. The method of claim 10 further comprising the steps of accessing a remote device containing a plurality of graphical representations by using wireless communications supported by the wireless mobile telephone, and downloading a selected graphical representation from the remote device for storage in the memory.

15. The method of claim 10 wherein the step of acquiring comprises utilizing a measurement module disposed within a housing of the wireless mobile telephone that uses a laser beam to determine distance.

16. The method of claim 15 wherein the step of acquiring comprises the step of depressing a button operable by a user to cause the acquiring of a linear distance measurement.

17. The method of claim 10 wherein the step of acquiring comprises operation of a measurement module coupled to and in the presence of the wireless mobile telephone that uses a laser beam to determine distance.

18. A computer-readable, tangible, signal-bearing medium comprising:
means in the medium for causing the storing in memory of a wireless mobile telephone a graphical representation of a structure having elements to be measured;
means in the medium for causing the displaying on a screen of the wireless mobile telephone the graphical representation;
means in the medium for causing the acquiring linear distance measurements to objects within line of sight of the wireless mobile telephone;
means in the medium for causing the storing in the memory each linear distance measurement together with an association with one of a selected element of the graphical representation as shown on the display screen.
